(19) United States
(12) Patent Application Publication
(10) Pub. No.: US 2009/0327761 A1
(43) Pub. Date: Dec. 31, 2009

(54) RECORDING MEDIUM, ATTACHING KIT FOR ATTACHING ENCRYPTION KEY STICKER TO THE RECORDING MEDIUM, AND RECORDING APPARATUS AND REPRODUCING APPARATUS FOR THE RECORDING MEDIUM

(75) Inventor: Masatoshi Adachi, Tokorozawa-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/524,679

(22) PCT Filed: Feb. 7, 2007
(86) PCT No.: PCT/JP2007/052092

§ 371 Date: Jul. 27, 2009

(51) Int. Cl. G06F 21/24; G11B 5/82

(52) U.S. Cl. 713/193; 360/135; G9B/5.293

(57) ABSTRACT

A sticker (42) having at least an encryption key (424) previously recorded in an electromagnetically and optically readable state is attached at a prescribed position of a recording medium (100). The recording medium is provided with a recording area (43) for recording data, which includes encryption data encrypted based on at least the encryption key recorded on the sticker, in the electromagnetically and optically readable state.

### TECHNICAL FIELD

The present invention relates to, for example, a recording medium which can relatively easily protect recorded content on a disk-shaped recording medium such as an optical disk, an attaching kit for attaching an encryption key sticker to the recording medium, and a recording apparatus and a reproducing apparatus for the recording medium.

### BACKGROUND ART

In order to protect content recorded on this type of recording mediums, an encryption key is used. For example, a patent document 1 discloses such a technique that recorded content is encrypted by using unique identification data of a recording medium as an encryption key, thereby illegal copy is prevented. According to this technique, data encrypted by a key which is disk identification data, which is read-only i.e. can not be rewritten, is recorded a user data area on the recording medium. Consequently, even if a user copies the user data area to other recording medium, the recording medium identification data can not be copied. Thus, it is possible to rule out correct decoding and reproducing the data.

Patent document 1: Japanese Patent Application Laid Open No. 2001-189015

### DISCLOSURE OF INVENTION

### Subject to be Solved by the Invention

However, the technique disclosed in the aforementioned patent document 1 for example, includes the following potential problem: though it is difficult to copy the recording medium illegally, reproducing this recording medium is relatively easy. Therefore, when a user hopes no one reproduces a recording medium, e.g. when a recording medium is scrapped, it is necessary to take the recording medium to pieces, thereby the user must use much user's energy.

In view of the aforementioned problem, it is therefore an object of the present invention to provide a recording medium which can relatively easily protect recorded content, an attaching kit for attaching an encryption key sticker to the recording medium, and a recording device and a reproducing device for the recording medium.

### Means for Solving the Subject

The above object of the present invention can be achieved by a recording medium provided with: a sticker having, which is attached to a predetermined position of said recording medium, at least an encryption key previously recorded on an electromagnetically and optically readable state; and a recording area for recording data, which includes encryption data encrypted based on at least the recorded encryption key, in the electromagnetically and optically readable state.

According to this invention, the sticker, on which at least an encryption key is previously recorded in an electromagnetically and optically readable state, is attached to the predetermined position of the recording medium. Here, “electromagnetically and optically readable” means it can be read by using physical phenomenon which is any one of electricity, magnetism and light. For example, the encryption key is recorded as a pattern such as a bar-code; information corresponding to the pattern may be readable on the basis of light intensity of return light corresponding to irradiated light. Alternatively, the encryption key may be electromagnetically readable such as an IC chip. Alternatively, the encryption key is recorded as direction of magnetic field; the encryption key may be readable by using the reading principle for a magnetic disk. Incidentally, if the aforementioned physical phenomenon is used, not only intensity but also amplitude or phase may be used in so far as a reproducing apparatus supports it. For example, if light is used, a pattern of the encryption key is not limited to monochrome; it may be recorded on the sticker by color or the principle of holography. The “predetermined position of said recording medium” is a position located in any one of a recording surface of the recording medium and a label surface which is a surface opposite the recording surface; preferably, a position located in movable range of an optical pickup installed an optical information recording/reproducing apparatus. Moreover, the thickness of the sticker is preferably in range where a focus mechanism of the optical pickup is workable in view of compatibility.

The data including the encryption data encrypted on the basis of at least the encryption key, which is recorded as described above, is recorded on the recording area in the electromagnetically and optically state. The recording area has for example groove tracks, land tracks and the like, which are formed in a spiral fashion or a concentric fashion. Here, the “data including encryption data” means unencrypted data may be recorded on the recording area in addition to the encryption data. A type of this data is no object. Namely, this data includes various data such as moving image data, sound data, text data and program. “Encrypted on the basis of at least the encryption key, which is recorded” means including the following manners: it is allowed to encrypt data on the basis of the encryption key and an other element, which is not the encryption key, recorded on the sticker; the encryption key recorded on the sticker is not used for encrypting data but used for indicating a key for encryption which is used for encrypting the data, i.e. the encryption key is indirectly used for encrypting the data.

Here, as pointed out in the aforementioned Subject to be Solved, when a user hopes no one reproduces a recording medium, e.g. when a recording medium is scrapped, it is necessary to take the recording medium to pieces, thereby the user must use much user's energy.

However, according to the recording medium of the present invention, since the encryption data, which will be recorded on the recording area, is encrypted on the basis of at least the encryption key recorded on the sticker, the encryption data can not be decoded if the sticker is peeled off.

Therefore, it is possible to relatively easily protect content recorded on the recording area, and it is extremely useful in practice.

In one aspect of the recording medium of the present invention, said recording medium has a disk shape (e.g. a shape like CD, DVD or BD), said sticker has a ring shape (in other words, a doughnut shape) or an arc shape, which is a part of the ring shape (in other words, the sticker basically has an arc shape; the arc-shaped sticker is proper to the ring-shaped sticker in a special case in which the central angle of the arc-shaped sticker is 360 degree), a center of a ring of said sticker coincides with a center of said disk-shaped recording medium (the term “coincide with” here means not only strict coinciding but also allowing the existence of a little margin as long as a recording apparatus or a reproducing apparatus can support it), and an external diameter of the ring of said sticker is less than a radius of said disk-shaped recording medium (i.e. the sticker fits into a recording surface of the recording medium).

According to this aspect, it is possible to read the encryption key recorded on the sticker with revolving the recording medium around the coinciding center by using a revolving device such as a spindle, as well as a usual reading manner for a recording medium. Incidentally, if the sticker has a ring shape, there is such a merit that an apparatus, other than a dedicated apparatus, can not keep a focus because a pickup inevitably crosses the sticker when the pickup is displaced in a radial direction. Moreover, when the sticker has an arc shape, similarly, it is possible to prevent keeping a focus if central angle of, a number of, a width of, or disposition of the sticker is some extent. Conversely, when the sticker has an arc shape, it is preferable that central angle of, a number of, a width of, disposition of the sticker and the like are specified as a value which can prevent keeping the focus by experiments, experiences or simulations.

In the aspect in which the sticker has a ring shape or an arc shape, which is a part of the ring shape, as described above, it is preferable that said attached sticker includes: a start detecting part indicating a reading start position of said sticker; a timing synchronous part for synchronizing a reading timing for a succeeding data; a standard position part indicating a standard position of said sticker in a circumferential direction; and the encryption key, and the start detecting part, the timing synchronous part, the standard position part and the encryption key are arranged in order of the start detecting part, the timing synchronous part, the standard position part and the encryption key along a reading direction.

According to this aspect, even if the recording medium is rotated, it is possible to precisely read the encryption key.

Alternatively, in the aspect in which the sticker has a ring shape or an arc shape, which is a part of the ring shape, as described above, it is preferable that an angle controlling mark is recorded on a position displaced from the standard position part by a predetermined angle along a circumferential direction.

According to this aspect, by verifying whether or not an angle between the angle controlling mark and the standard position part of the sticker is the predetermined angle, it is possible to confirm whether or not the sticker is once peeled off and then attached again, i.e. to confirm possibility of illegal access or illegal copy. A protection for the recorded data becomes strong by judging whether or not reproduction is allowed in accordance with the verification.

In the aspect in which the angle controlling mark is recorded as described above, it is preferable that the predetermined angle is derived on the basis of at least unique identification data of said recording medium in recording the angle controlling mark.

According to this aspect, the predetermined angle is a unique value of the recording medium. Therefore, even if a copy is made by imitating the angle between the standard position part and the angle controlling mark, an angle of the copied disk is not a correct angle because unique information of the original recording medium and that of the copied recording medium are different each other. Therefore, reliability is improved in confirming the possibility of illegal access or illegal copy. Incidentally, if unique identification data is not recorded on the recording medium in advance, by way of compensation, the predetermined angle may be derived by using the encryption key. In this case, copying becomes more difficult compared with a case in which the angle controlling mark is formed next to the standard position part.

In another aspect of the present invention, said attached sticker partially separates if said attached sticker is once peeled off.

According to this aspect, even if the sticker is once peeled off and then put back, it is possible to visually judge the sticker has been peeled off visually.

In the aspect in which the sticker has a ring shape or an arc shape, which is a part of the ring shape, as described above, said recording area also has a ring shape in said disk-shaped recording medium, a center of said ring-shaped recording area coincides with the center of said disk-shaped recording medium, and said recording medium is further provided with an information area, where unique information which is needed in recording or reproducing is recorded, at an inside of said attached sticker.

According to this aspect, before recording or reproducing, the unique information, which is preliminarily recorded on the information area at the time of manufacture, is read; a setup is performed on the basis of this information.

In the aspect in which the information area is further provided, it is preferable that an internal diameter of the ring of said sticker is less than an internal diameter of said ring-shaped recording area.

According to this aspect, in recording or reproducing, since a pickup is displaced from the recording area to the information area in order to read the unique information, the pickup crosses the sticker. Therefore, it is possible to obtain a recording medium which can be recorded or reproduced by only a dedicated recording or reproducing apparatus being capable of focusing in accordance with the thickness of the sticker.

Alternatively, in the aspect in which the information area is further provided, it is preferable that an internal diameter of the ring of said sticker is larger than an internal diameter of said ring-shaped recording area, and the external diameter of the ring of said sticker is less than an external diameter of said ring-shaped recording area.

According to this aspect, since the recording area is divided by the sticker, it is possible to use an inner circumference side of the recording area as an area where unencrypted data is recorded, and to use an outer circumference side of the recording area as an area where encryption data is recorded, for example. By such construction, it is possible to make a host recognize that there are two recoding mediums.

If said sticker has an arc shape, it is preferable that a plurality of arc-shaped stickers are located on an identical radial position of said disk-shaped recording medium.

According to this aspect, since the sticker has an arc shape, it is possible to arrange a plurality of stickers (preferably, more than three stickers) in a balanced manner with saving space compared with a ring-shaped sticker. Incidentally, in this case, by judging whether or not each of angles between the angle controlling mark and the standard position part of all of or a part of the plurality of stickers is appropriate in reproducing or recording, it is possible to confirm possibility of illegal access or illegal copy.

In the aspect in which the plurality of arc-shaped stickers are arranged, it is preferable that the encryption key is recorded on any one of the plurality of arc-shaped stickers.

According to this aspect, security is improved compared with a case in which all of the plurality of arc-shaped stickers have the same encryption key.

Alternatively, in the aspect in which the plurality of arc-shaped stickers are arranged, the encryption key may be separately recorded on each of the plurality of arc-shaped stickers.

According to this aspect, it is necessary to rebuild the encryption key by reading each of encryption keys separately recorded in decoding. Therefore, security is more improved compared with a case in which the encryption key is recorded on one sticker.

An attaching kit of the present invention for attaching said arc-shaped sticker according to any one of claims 10 to 12 to said recording medium, which has a disk shape, said attaching kit is provided with: a pasteboard which is transparent and has an oblong shape; said arc-shaped sticker, which is attached to said pasteboard by one surface where the encryption key is recorded, and has other surface which is an attaching surface for attaching said arc-shaped sticker to said recording medium; a protection sheet for protecting the attaching surface; a board-hole, whose diameter is equal to a center hole formed in said recording medium, for adjusting a center; and an angle mark, which is placed at a surrounding area of said board-hole, for adjusting an attaching angle of each of said plurality of arc-shaped stickers.

According to this aspect, first, the center hole formed in the recording medium is set at a projection of a disk case. Board-holes of a plurality of attaching kits corresponding to the plurality of stickers are set at the projection from above the recording medium, in a similar way. An aspect of each of the plurality of attaching kits is adjusted around the projection of the disk case by using the angle mark which is formed every 60 degree, for example. After adjusting the aspect as described above, the protection sheet of each of the plurality of kits is peeled off, thereby the attaching surface of each of arc-shaped stickers is attached to a desired position of the recording medium. By this means, it is possible to preferably attach the plurality of arc-shaped stickers to the recording medium as follows.

The above object of the present invention can be achieved by a recording apparatus for recording data on the recording medium according to any one of claims 1 to 12, said recording apparatus is provided with: a reading device for electromagnetically and optically reading an encryption key which is recorded on a stacker attached to said recording medium; an encrypting device for encrypting recording target data on the basis of at least the read encryption key; and a recording device for recording the encrypted recording target data on said recording medium.

According to the recording apparatus of the present invention, it is possible to preferably record data on the aforementioned recording medium of the present invention.

Incidentally, even in the recording apparatus of the present invention, it is possible to suit with various aspects of the aforementioned recording medium of the present invention. Specifically, for example, it is possible to perform focusing in accordance with the thickness of the sticker, to confirm whether or not the angle between the angle controlling mark and the standard position part of the sticker is the predetermined angle, or to record with performing translation of relating a record address in a case in which the sticker is not used to the recoding area.

The above object of the present invention can be achieved by a reproducing apparatus for reproducing an encryption data recorded on the recording medium according to any one of claims 1 to 12, said reproducing apparatus is provided with: a reading device for electromagnetically and optically reading an encryption key which is recorded on a stacker attached to said recording medium, and the recorded encryption data; and a decoding device for decoding the read encryption data on the basis of the read encryption key.

According to the reproducing apparatus of the present invention, it is possible to preferably reproduce the encryption data recorded on the aforementioned recording medium of the present invention.

Incidentally, even in the reproducing apparatus of the present invention, it is possible to suit with various aspects of the aforementioned recording medium of the present invention. Specifically, for example, it is possible to perform focusing in accordance with the thickness of the sticker, to confirm whether or not the angle between the angle controlling mark and the standard position part of the sticker is the predetermined angle, or to reproduce with adjusting an address for host arbitrarily.

As explained above, according to the recording medium of the present invention, since it is provided with the sticker and the recoding area, it is possible to relatively easily protect content recorded on the recording area, so that it is extremely useful in practice. According to the attaching kit of the present invention, since it is provided with the pasteboard, the arc-shaped sticker, the protection sheet, the board-hole and the angle mark, it is possible to preferably attach an encryption key sticker to the recording medium. According to the recoding apparatus of the present invention, since it is provided with the reading device, the encrypting device and the recording device, it is possible to preferably record data on the aforementioned recoding medium of the present invention. According to the reproducing apparatus of the present invention, since it is provided with the reading device and the decoding device, it is possible to preferably reproduce the encryption data recorded on the aforementioned recording medium of the present invention.

The operation and other advantages of the present invention will become more apparent from the examples explained below.

### BRIEF DESCRIPTION OF DRAWINGS

FIG. 1 is a block diagram conceptually showing the basic structure of a recording/reproducing apparatus 1, which can record or reproduce a recording medium 100 of a first example of the present invention.

FIG. 2 are a top view and a cross-sectional view conceptually showing the basic structure of the recording medium 100 of the first example.

FIG. 3 is a perspective view schematically showing the recording medium 100 and a sticker 42 attached to a recording surface of the recording medium 100 in the first example.

FIG. 4 is a perspective view showing a condition in which the sticker 42, which attached to the recording medium 100 of the first example, is partially peeled off.

FIG. 5 is a top view showing a basic structure of data recorded on the sticker 42 of the first example.

FIG. 6 is a top view showing a positional relationship between the sticker 42 attached to the recording medium 100 and a sticker-angle control mark 45 in the first example.

FIG. 7 is an expanded cross-sectional view of the recording medium 100 showing a focus state of a recording/reproducing apparatus 1 of the first example.

FIG. 8 is a characteristic view showing a relationship between lens height of the recording/reproducing apparatus 1, and each of focus error signal and return light intensity in the first example.

FIG. 9 is a conceptual diagram temporally showing a condition in which the recoding medium 100 of the first example is recorded or reproduced by a general recording/reproducing apparatus with a cross-sectional view of the recording medium 100.

FIG. 10 is a conceptual diagram temporally showing a condition in which the recording medium 100 of the first example is recorded or reproduced by the recording/reproducing apparatus 1 of the first example with the cross-sectional view of the recording medium 100.

FIG. 11 is a flowchart showing the operation of the recording/reproducing apparatus 1 of the first example.

FIG. 12 is a cross-sectional view showing the data formation of the recording medium 100 and various addresses corresponding to the data formation in the first example.

FIG. 13 are a top view and a cross-sectional view conceptually showing the basic structure of a recording medium 100 of a second example.

FIG. 14 are a top view and a cross-sectional view conceptually showing the basic structure of a recording medium 100 of an altered embodiment of the second example.

FIG. 15 is a conceptual diagram temporally showing a condition in which the recording medium 100 of the second example is recorded or reproduced by a general recording/reproducing apparatus with the cross-sectional view of the recording medium 100.

FIG. 16 is a conceptual diagram temporally showing a condition in which the recording medium 100 of the second example is recorded or reproduced by a recording/reproducing apparatus 1 of this example with the cross-sectional view of the recording medium 100.

FIG. 17 is a flowchart showing the operation of the recording/reproducing apparatus 1 of the second example.

FIG. 18 is a cross-sectional view showing the data formation of the recording medium 100 and various addresses corresponding to the data formation in the second example.

FIG. 19 are a top view and a cross-sectional view conceptually showing the basic structure of a recording medium 100 of a third example.

FIG. 20 is a perspective view schematically showing the recording medium 100 and three stickers attached to the recording surface of the recoding medium 100 in the third example.

FIG. 21 is a cross-sectional view conceptually showing the basic structure of a sticker attaching kit 4200 of the third example.

FIG. 22 is a top view conceptually showing attaching condition in which three arc-shaped stickers 4201 are attached by using the sticker attaching kit 4200 of the third example.

### DESCRIPTION OF REFERENCE CODES

1 recoding/reproducing apparatus
11 spindle motor
12 optical pickup unit
13 optical pickup
14 thread
15 stepping motor
16 OPU controller
17 stepping controller
18 spindle controller
31 system controller
32 memory
411 recording-power adjusting part
412 disk information part
42 sticker
44 sticker-angle controlling part
45 sticker-angle controlling mark
43 encryption data recording part
420 sticker separation part
421 start detecting part
422 timing synchronization part
423 standard position part
424 encryption key
425 center gap detecting guide
46 recording layer
426 sticker data layer
427 sticker protection layer
462 sticker-surrounding impossibly accessing part
430 normal user data area
47 unencrypted data recording part
431 second encryption key recording part
4200 sticker attaching kit
4205 pasteboard
4201 arc-shaped sticker
4204 protection sheet
4206 board-hole
4207 angle mark

### BEST MODE FOR CARRYING OUT THE INVENTION

Hereinafter, an explanation will be given on the best mode for carrying out the present invention with reference to the drawings with respect to each example, in turn. Incidentally, this example relates to not only a recording medium but also an attaching kit, a recording apparatus and a reproducing apparatus.

### (1) First Example

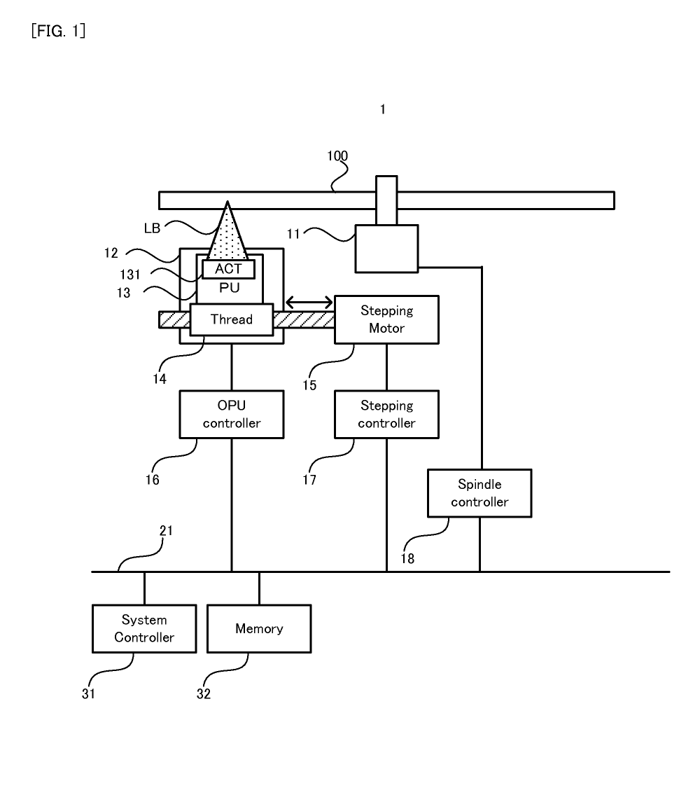

With reference to FIG. 1 to FIG. 12, an explanation will be given on a recording medium 100, and the structure and operation processing of a recording/reproducing apparatus 1 which can record and reproduce the recording medium 100 in the first example.

(1-1) Structure

FIG. 1 is a block diagram conceptually showing the basic structure of the recording/reproducing apparatus 1, which can record or reproduce the recording medium 100 of the first example.

In FIG. 1, the recording/reproducing apparatus 1 performs recording and reproducing the recording medium 100. The recording/reproducing apparatus 1 is provided with a spindle motor 11, an optical pickup (OPU) unit 12, an optical pickup 13, a thread 14, a stepping motor 15, an OPU controller 16, a stepping controller 17, a spindle controller 18, a system controller 31 and a memory 32.

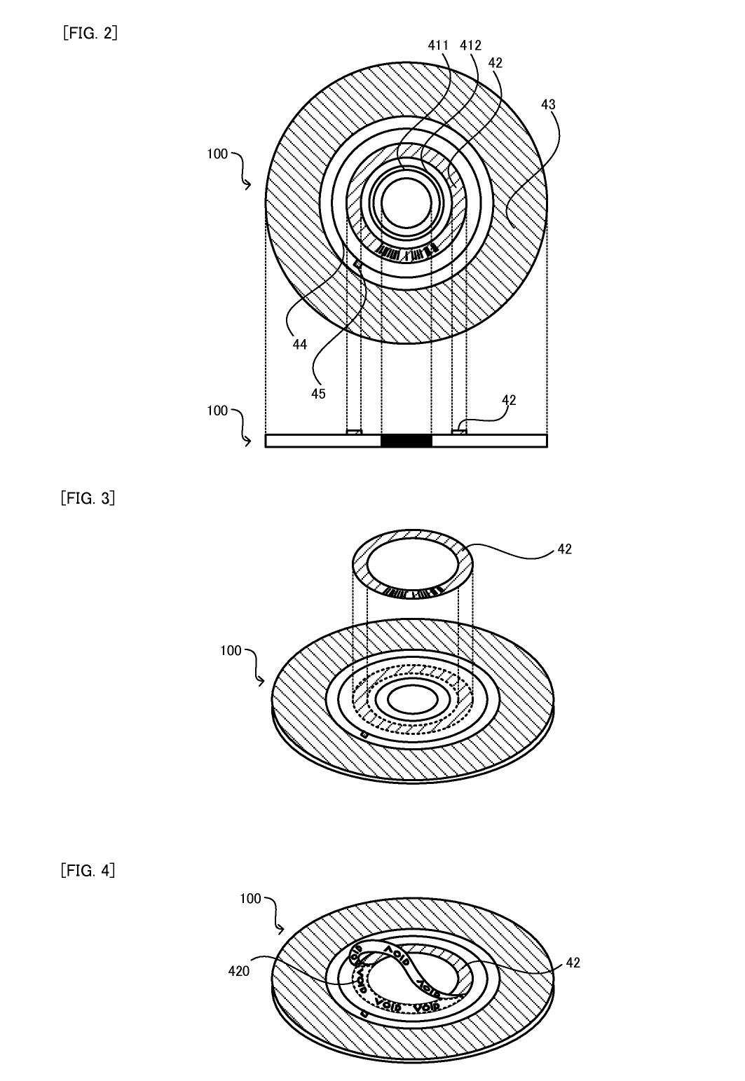

The recording medium 100 is one specific example of the “recording medium” of the present invention, and is a disk-shaped recording medium such as an optical disk. Its specific structure will be explained later with reference to FIG. 2 to FIG. 6.

The spindle motor 11 is a motor for rotating and stopping the recording medium 100. More circumstantially, the spindle motor 11 is adapted to rotate the recording medium 100 at a predetermined speed and stop it with receiving spindle servo under control of the spindle controller 18.

The optical pickup unit 12 is a case for holding the optical pickup 13 and the thread 14.

The thread 14 is subjected to a driving force by the stepping motor 15 and is displaced in a radial direction of the recording medium 100 with the optical pickup unit 12.

The stepping motor 15 displaces the thread 14 in the radial direction of the recording medium 100, in accordance with a voltage applied by the stepping controller 17.

The optical pickup 13 is provided with an actuator 131 or the like capable of oscillating, for example, a semiconductor laser device, a collimator lens, a light receiving element, an objective lens and a lens holder for the objective lens, which are not illustrated, with respect to a plurality of axes in order to perform data recording and reproduction on the recording medium 100. The position of the optical pickup 13 in the radial direction of the recording medium 100 is adjusted by displacement of the thread 14 caused by the stepping motor 15, and the position is further finely adjusted by the actuator 131 disposed in the optical pickup unit 12. By this actuator 131, it is possible to adjust the irradiation position of a laser beam LB at least in a focus direction. The optical pickup 13 irradiates the laser beam LB to the recording medium 100 as reading light with a first power in the reproduction, and as writing light with a second power with it modulated in recording.

The OPU controller 16 is provided with, for example, a laser diode driver or the like, and it controls operation of irradiating the laser beam LB by the optical pickup 13. Specifically, the OPU controller 16 controls power, irradiation timing, irradiation position and the like of the laser beam LB (in other words, operations of the optical pickup 13) in cooperation with the stepping controller 17 and the spindle controller 18, under control of the system controller 31.

The stepping controller 17 controls the voltage to be applied to the stepping motor 15, thereby controlling the amount of displacement of the thread 14 caused by the stepping motor 15. Specifically, the stepping controller 17 controls the amount of displacement of the thread 14 (in other words, operations of the stepping motor 15) in cooperation with the OPU controller 16 and the spindle controller 17, under control of the system controller 31.

The spindle controller 18 controls the rotation of the recording medium 100 caused by the spindle motor 11. Specifically, the spindle controller 18 controls the rotational speed, rotational angle or the like of the recording medium 100 (in other words, operations of the spindle motor 11) in cooperation with the OPU controller 16 and the stepping controller 17, under control of the system controller 31.

The system controller 31, in company with the memory 32, is connected to the OPU controller 16, the stepping controller 17, the spindle controller 18 and the memory 32 through a data bus 21. The system controller 31 outputs a control command to each or the OPU controller 16, the stepping controller 17 and the spindle controller 18, thereby controlling the entire recording/reproducing apparatus 1.

The memory 32 is composed of a ROM area where a program for the recording/reproducing apparatus 1 operating (i.e. firmware) is stored; a RAM area where data used during the operation by the recording/reproducing apparatus 1 is temporally stored; and the like.

Next, with reference to FIG. 2 to FIG. 6, a detailed explanation will be given on the recording medium 100 of the first example, which can be recorded and reproduced by the recording/reproducing apparatus 1 constructed as described above.

FIG. 2 are a top view and a cross-sectional view conceptually showing the basic structure of the recording medium 100 of the first example.

In FIG. 2, the recording medium 100 of the first example has a disk shape whose diameter is, for example, about 12 cm as well as a DVD or the like. In the recording surface of the recording medium 100, a recording-power adjusting part 411, a disk information part 412, a sticker 42, a sticker-angle controlling part 44 and an encryption data recording part 43 are disposed in a direction from a center hole toward outer circumference side.

The recording-power adjusting part 411 is an area for an adjustment where a test recording is performed in order to adjusting a recording-power. In other words, the recording-power adjusting part 411 is an area for an OPC (Optimum Power Control) processing of calibrating light intensity of the laser beam LB.

The disk information part 412 is an area where a unique value of the recording medium 100—specifically, a unique parameter and format information which are needed in recording or reproducing the recording medium 100—is stored. Specifically, for example, an applicable specification of a recording medium (e.g. DVD-RW, DVD-R, DVD-RAM or the like) and a part version, a data capacity and minimum reading rate, a disk structure (single layer disk, double layer disk or the like), recording density, data area allocation, reading power, peak power, bias power, all kinds of information concerning manufacturing a medium, and the like are stored as the format information.

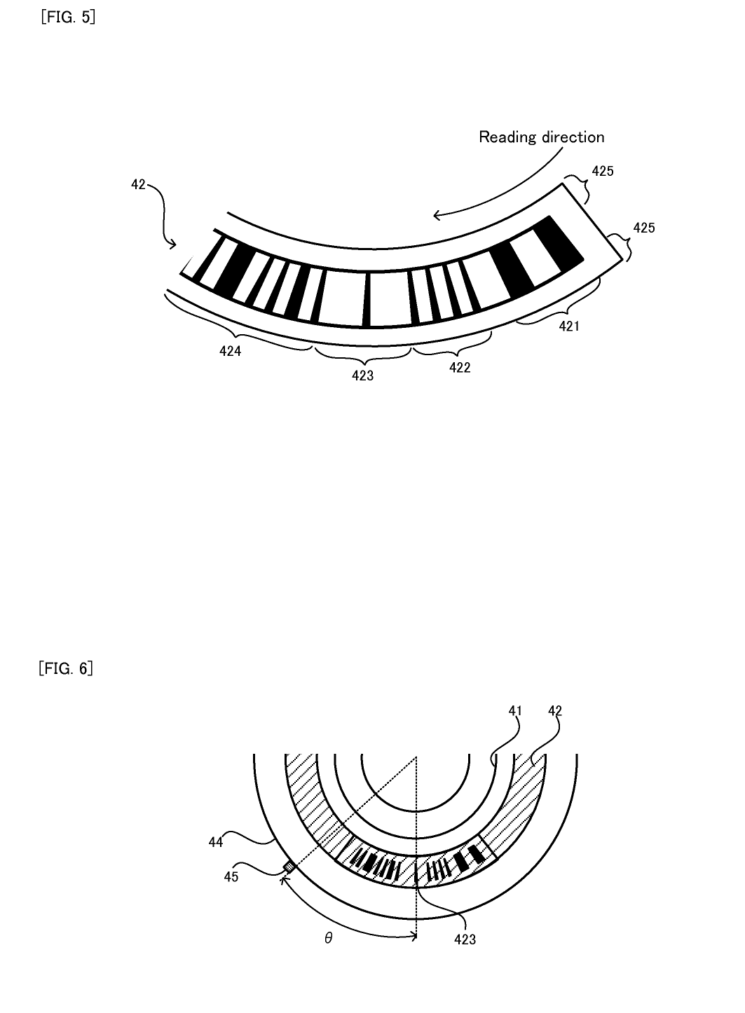

The sticker 42 is attached to the recording surface of the recording medium 100. However, it is possible to attach the sticker 42 to the label surface, which is the opposite surface of the recording surface. In that case, a device which can read the sticker 42 on the label surface is needed. In the sticker 42, an encryption key 424 (cf. FIG. 5) for encrypting data which is recorded on the encryption data recording part 43, and for decoding recorded encryption data is recorded. The term a method of encryption here is, for example, the secret key cryptography in which the same key is used for encryption and decryption. But, it is not limited to this method as long as encryption and decryption are performed by using the encryption key 424. Moreover, a key used here is not limited to the encryption key 424, which is read from the sticker 42. In addition to the encryption key 424, information obtained from a user or information preliminarily recorded on the recording medium 100 may be used. Since the sticker 42 is used for encryption and decryption as described above, in a condition in which the sticker 42 is peeled off, it is impossible to decrypt and reproduce the encryption data recorded on the encryption data recording part 43. Therefore, only peel off the sticker 42, it is possible to easily scrap the recording medium 100 with protecting the recorded encryption data. Incidentally, since the sticker 42 assumes an important role as described above, it is preferable that the shape of the sticker 42 is held by a pasteboard located in the opposite surface of the attaching surface, which is attached to the recording medium 100, for example. The sticker 42 will be explained later with reference to FIG. 3 to FIG. 6.

The sticker-angle controlling part 44 is an area where the sticker-angle controlling mark 45 as a mark which is a standard for judging whether or not the attaching position of the sticker 42 is correct is recorded by the laser beam LB.

The encryption data recording part 43 is an area where the encryption data, which is encrypted on the basis of the encryption key 424 obtained from the sticker 42, is written. In this area, a groove track, a land track and the like are formed in a spiral or in concentric circles which centers on the center hole as well as a recording medium such as CD and DVD. On this track, the encryption data is recorded by a unit of ECC block. The number of times of record may be only one or plural times. Various recording methods such as a magneto optical method or a phase-change method can be adopted as a recording method.

Next, with reference to FIG. 3 to FIG. 6, an additional explanation will be given on the sticker 42.

FIG. 3 is a perspective view schematically showing the recording medium 100 and a sticker 42 attached to a recording surface of the recording medium 100 in the first example.

As shown in FIG. 3, the sticker 42 has a ring shape with inner diameter of 25 mm and outer diameter of 30 mm, for example. The sticker 42 is attached to denude the recording surface of the recording medium 100 in at least any one of the inner circumference side and the outer circumference side of the sticker 42 after attaching. But, the sticker 42 need not necessarily have a ring shape. The sticker 42 may have a size and a shape which can prevent sequential tracing of a normal apparatus.

FIG. 4 is a perspective view showing a condition in which the sticker 42, which attached to the recording medium 100 of the first example, is partially peeled off.

As shown in FIG. 4, it is preferable that the sticker 42 has a bonding surface structure which can make an owner of the recording medium 100 recognize the sticker 42 has been peeled off if the sticker 42 is once peeled off. According to this structure, since the sticker 42 is once peeled off in order to copy the recording medium 100 of this example by using a normal drive, it is possible to easily recognize performing an illegal copy. Incidentally, the bonding surface structure having the aforementioned feature may be as follows: a type in which it is impossible to attach the sticker 42 again after peeling off from an adherend; a type in which it is possible to visually discriminate peeling off after peel-off. The former type is realized by bonding the bonding surface of the sticker 42 with an adhesive which can not bond with normal pressure after peeled off once. The latter type is, for example, realized as follows: a sticker separation part 420 is formed on the bonding surface of the sticker 42; adhesion force of the sticker separation part 420 is greater than that of the other part; when the sticker 42 is peeled off once, the sticker 42 is separated remaining the sticker separation part 420 on the recording medium 100.

FIG. 5 is a top view showing a basic structure of data recorded on the sticker 42 of the first example.

As shown in FIG. 5, the sticker 42 is provided with a stat detecting part 421 indicating a reading start position of the sticker, a timing synchronization part 422 for synchronizing a reading timing for succeeding information, a standard position part 423 indicating a standard position of the sticker 42 and the encryption key 424. They are arranged in order of the stat detecting part 421, the timing synchronization part, the standard position part 423 and the encryption key 424 along a reading direction. In this structure, the encryption key 424 is optically read along the reading direction by the optical pickup 13. Moreover, a gap between the center of the sticker 42 and the center of the recording medium 100 is detected on the basis of a center gap detecting guide 425, thereby the read data is corrected as occasion demands.

FIG. 6 is a top view showing a positional relationship between the sticker 42 attached to the recording medium 100 and a sticker-angle control mark 45 in the first example.

As shown in FIG. 6, the angle formed by the straight line connecting the standard position part 423 of the sticker 42 attached to the recording medium 100 and the center of the recording medium 100, and the straight line connecting the sticker-angle controlling mark 45 and the center of the recording medium 100 is θ. Here, the angle θ is a unique angle of the recording medium 100. The angle θ is determined in the range of 0<θ<360 on the basis of a unique identification data of the disk included in the disk information part 412, for example. The sticker-angle controlling part 45 is recorded on an area on the sticker-angle controlling part 44, which is revolved around the center of the recording medium from the standard position part 423 of the sticker 42 by the angle θ, in writing the encryption data in the encryption data recording part 43. At this time, since it is possible to estimate the aforementioned angle θ on the basis of the standard position part 423 of the sticker 42 and the unique identification data of the disk included in the disk information part 412, it is also possible to estimate a position where the sticker-angle controlling mark 45 is recorded. On the other hand, in reproducing the recording medium 100, it is possible to detect abnormality concerning the position of the sticker 42 by a fact that the sticker-angle controlling mark 45 is not recorded at the aforementioned estimated position. In this case, it is possible to stop reproduction considering as follows: a person, who tries to illegally copy the recording medium 100, has once peeled off the sticker 42; then the person has attached a sticker copied by such as optical copying, but the person has not considered the sticker-angle controlling mark 45 and the angle θ.

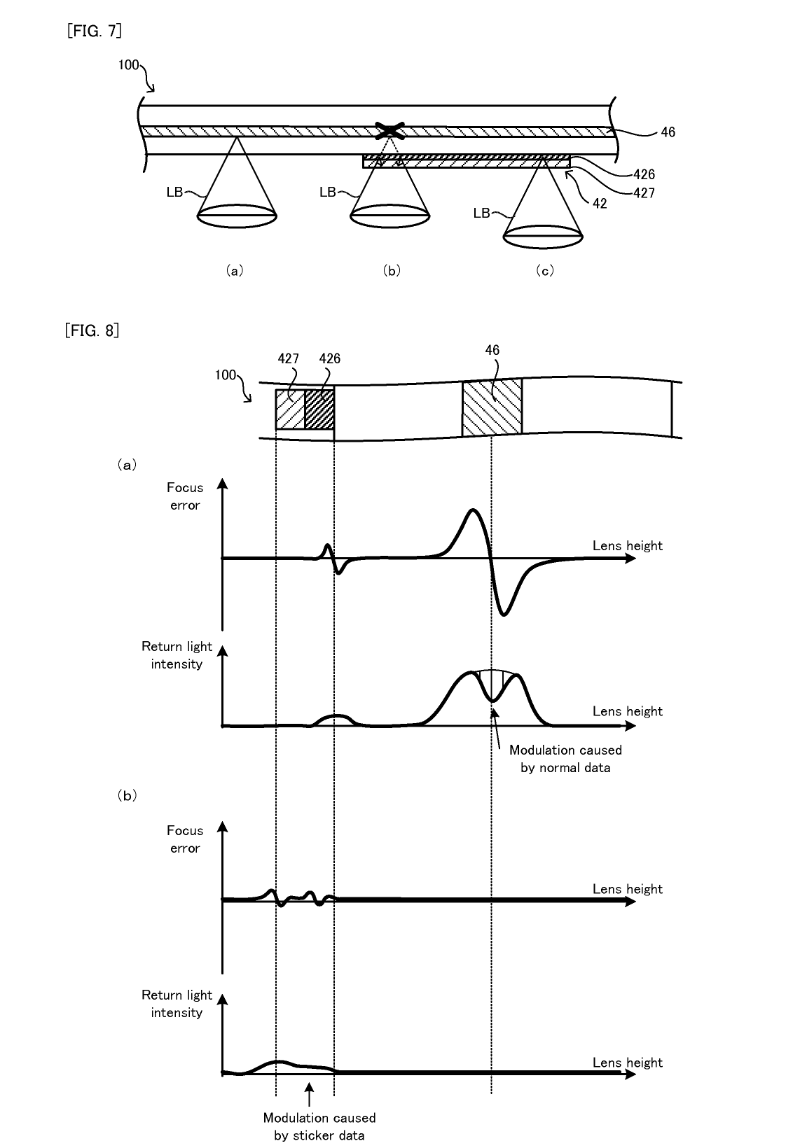

FIG. 7 is an expanded cross-sectional view of the recording medium 100 showing a focus state of a recording/reproducing apparatus 1 of the first example.

As shown in FIG. 7, a recording layer 46 is included in the laminated structure of the recording medium 100. The sticker 42 is attached to the recording surface of the recording medium 100. This sticker 42 has a laminated structure including a sticker data layer 426 and a sticker protection layer 427. Here, FIG. 7 shows three focus states (a)˜(c). The focus states will be explained starting from the left. As shown in FIG. 7(a), if the irradiation position of the laser beam LB is the outside of the sticker 42, when a focus is taken on the recording layer 46 by the actuator 131, it is possible to keep the focus because an optical condition is met. On the other hand, as shown in FIG. 7(b), if the irradiation position of the laser beam LB is the inside of the sticker 42, it is impossible to keep a focus on the recording layer 46 because an optical condition is not met by reflection at the sticker data layer 426 or the like for example. In this case, as shown in FIG. 7(c), when a focus is taken at the sticker data layer 426 by the actuator 131 detaching the objective lens by predetermined amount, since an optical condition is met, it is possible to keep the focus even if the sticker 42 is attached. According to whether or not it is possible to keep a focus as describe above, the recording medium 100 of the first example restricts a general recording/reproducing apparatus to record and to reproduce; on the other hand, the recording medium 100 allows the recording/reproducing apparatus 1 of the first example to record and to reproduce.

The structure is as described above, so relationships between the lens height of the objective lens in a light axis direction and each of a focus error signal and return light intensity are different from each other according to whether or not the irradiation position of the laser beam LB is in the sticker 42. With reference to FIG. 8, an additional explanation will be given on these relationships.

FIG. 8 is a characteristic view showing a relationship between lens height of the recording/reproducing apparatus 1 and each of focus error signal and return light in the first example (a: the irradiation position of the laser beam LB is in the sticker 42; b: the irradiation position of the laser beam LB is out of the sticker 42).

As shown in FIG. 8(a), if the irradiation position of the laser beam LB is out of the sticker 42, when the lens height is a height where the laser beam LB is focused on each of the recording layer 46 and the surface of the recording medium 100, the amplitude of each of the focus error signal and the return light intensity is relatively expanded or the peak value of each of the focus error signal and the return light intensity is risen because the laser beam LB reaches the recording layer 46 without being reflected by the sticker 42 (this specific characteristic is called “Sigmoid” of the focus error and the return light intensity). On the other hand, as shown in FIG. 8(b), if the irradiation position of the laser beam LB, the phenomenon does not become as described above because the laser beam LB is reflected by the sticker 42 and thereby the laser beam LB does not reach the recording layer 46. Alternatively, the amplitude of each of the focus error signal and the return light intensity is relatively expanded or the peak value of each of the focus error signal and the return light intensity is risen when the lens height is a height where the laser beam LB is focused on each of the sticker data layer 426 and the surface of the sticker 42.

As described above, since the fluctuation of each of the focus error signal and the return light intensity is different according to whether or not there is the sticker 42 when the lens height of the objective lens is changed, inversely, it is possible to judge whether or not there is the sticker 42 on the basis of this difference.

(1-2) Operation

Next, a explanation will be given on an operation at a time when the recording medium 100 is recorded or reproduced by each of a general recording/reproducing apparatus and the recording/reproducing apparatus 1 of the first example.

(1-2-1) Operation of General Recording/Reproducing Apparatus

FIG. 9 is a conceptual diagram temporally showing a condition in which the recoding medium 100 is recorded or reproduced by the general recording/reproducing apparatus with a cross-sectional view of the recording medium 100.

As the cross-sectional view of the recording medium 100 shown in FIG. 9, the recording layer 46 of the recording medium 100 of the first example is composed of the recording-power adjusting part 411, disk information part 412, a sticker-surrounding impossibly accessing part 462, sticker-angle controlling mark 45 and the encryption data recording part 43, which are formed in the direction from the center hole to the outer circumference side. Here, the sticker-surrounding impossibly accessing part 462 is an area where it is impossible to access the recording area 46 because the sticker 42 is attached on the recording surface.

When the aforementioned recording medium 100 is recorded or reproduced by the general recording/reproducing apparatus, the operation is as shown in FIG. 9(a) to FIG. 9(c). First, as shown in FIG. 9(a), when a start-up operation is performed with a condition in which the irradiation position of the laser beam LB is in the sticker-surrounding impossibly accessing part 462, the start-up fails because there is the sticker 42 as foreign substance at the start-up position. On the other hand, as shown in FIG. 9(b), when the start-up operation is performed with a condition in which the irradiation position of the laser beam LB is out of the sticker-surrounding impossibly accessing part 462, the start-up succeeds because there is not the sticker 42. However, in this case, the optical pickup 13 will be displaced such that the optical pickup 13 crosses over a part where the sticker 42 is attached in order to perform reading data such as disk information part 412 recorded on the inner circumference. At this time, as shown in FIG. 9(c), since an optical condition is not met due to the sticker 42, it is impossible to keep a focus, and thereby an accessing fails. In consequence, it is said that the recording medium 100 is a recording medium which can not be recorded and reproduced by the general recording/reproducing apparatus.

(1-2-2) Operation of Recording/Reproducing Apparatus 100 of First Example

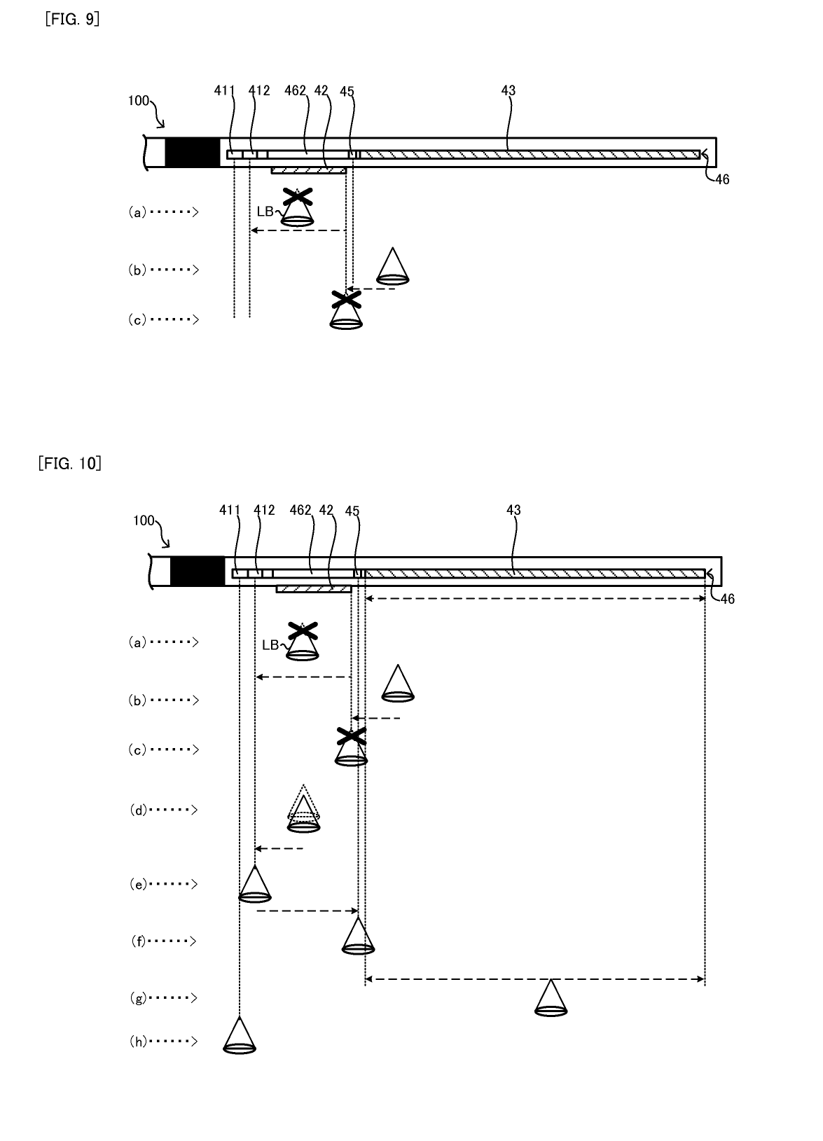

With reference to FIG. 10 to FIG. 12, an explanation will be given on the operation of the recording/reproducing apparatus 100 of the first example.

FIG. 10 is a conceptual diagram temporally showing a condition in which the recording medium 100 of first example is recorded or reproduced by the recording/reproducing apparatus 1 of this example with the cross-sectional view of the recording medium 100.

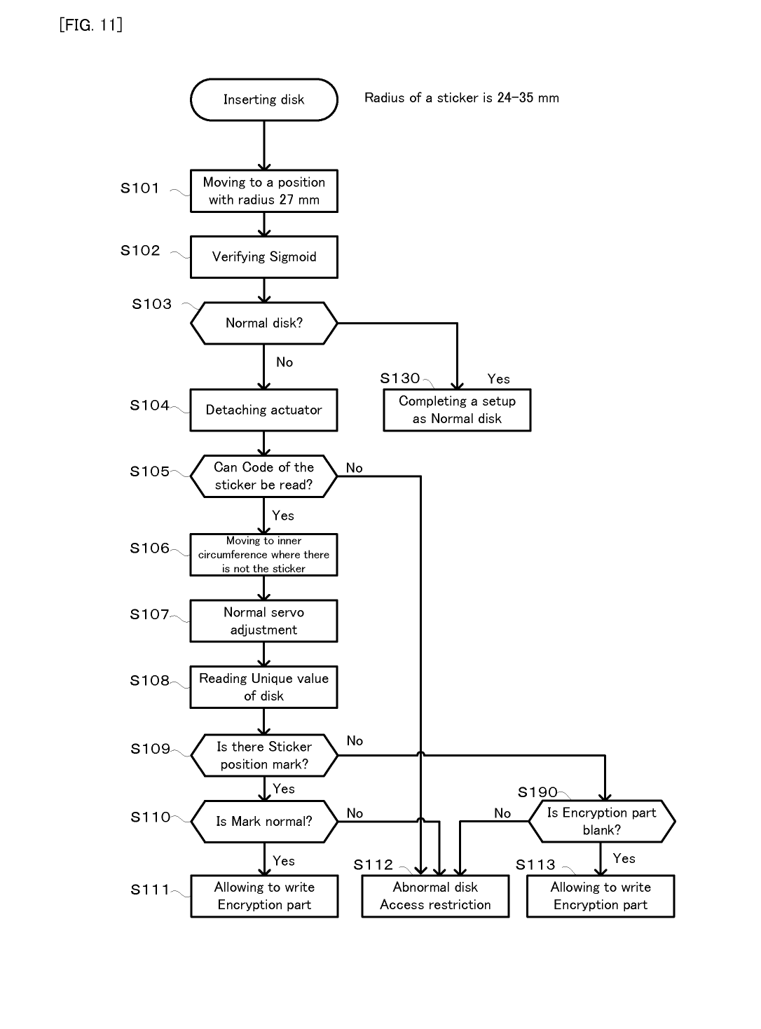

As shown in FIG. 10(a) to FIG. 10(h), the recording/reproducing apparatus 100 of the first example can record and reproduce the recording medium 100 of the first example unlike the general recording/reproducing apparatus shown in FIG. 9. An additional explanation will be given on the FIG. 10(a) to FIG. 10(h) with relating to steps of the flowchart in FIG. 11.

FIG. 11 is a flowchart showing the operation of the recording/reproducing apparatus 1 of the first example.

As shown in FIG. 11, the recording/reproducing apparatus 1, first, displaces the optical pickup 13 to a position with radius 27 mm on the recording medium 100, in other words in a range of 24˜35 mm in radius where there is the sticker 42 (step S101). Then, “Sigmoid” explained by using FIG. 8 is verified (step S102). In other words, it is verified whether or not there is the sticker 42. Consequently, it is judged whether a recording medium as a recording target or a reproducing target is the general recording medium (i.e. a recording medium which is not attached to the sticker 42) or is the recording medium 100 of the first example (step S103). Here, if it is judged that the recording medium is the general recording medium (the step S103: YES), since a special adjustment is unnecessary, a setup is completed as a normal recording medium (step S130). On the other hand, if it is judged that the recording medium is the recording medium 100 of the first example (the step S103: No), the objective lens is detached by the actuator 131 such that the lens height becomes a height where the laser beam LB is focused on the sticker data layer 426 (step S104). This condition is shown in FIG. 10(d). Consequently, the focus is kept. Then, it is judged whether or not a code recorded on the sticker data layer 426 of the sticker 42 (especially, the encryption key 424) can be read by the optical pickup 13 (step S105). Here, if it is possible to read the code (the step S105: YES), the read encryption key 424 is stored in the memory 32, and the optical pickup 13 is further displaced to the inner circumference (step S106). Then, a normal servo adjustment is performed (step S107), after that, a disk unique value is read from the disk information part 412 (step S108). This condition is shown in FIG. 10(e). Next, the optical pickup 13 is displaced to the position of the sticker-angle controlling part 44 in the outer circumference, and it is judged whether or not there is the sticker-angle controlling mark 45 (step S109). This condition is shown in FIG. 10(f). Here, if there is the sticker-angle controlling mark 45 already (the step S109: YES), it is judged whether or not the position of the sticker-angle controlling mark 45 is correct (step S110). Specifically, as explained with reference to FIG. 6, it is judged whether or not the position of the sticker-angle controlling mark 45 meets the estimated angle θ. Here, if it is judged that the position of the sticker-angle controlling mark 45 is correct (the step S110: YES), it is allowed to record data on the encryption data part 43 (step S111). This condition is shown in FIG. 10(g). Incidentally, an OPC processing for determining power at this time is performed at the recording-power adjusting part 411. This condition is shown in FIG. 10(h). On the other hand, if there is not the sticker-angle controlling mark 45 (the step S109: NO), it is judged whether or not the encryption data recording part 43 is blank (step S190). Here, if it is blank (the step S190: YES), it is allowed to record on the encryption data recording part 43 (step S113). On the other hand, if it is impossible to read the code (the step S105: No), or if the encryption data recording part 43 is recorded though there is not the sticker-angle controlling mark 45 (the step S190: NO), it is restricted to access to the encryption data recording part 43 because the recording medium 100 is abnormal i.e. there is a possibility that the sticker 42 is illegally copied or is once peeled off (step S112). As described above, legal recording and reproducing are allowed, but illegal recording and reproducing are not allowed.

Therefore, according to the recording medium 100 of the first example and the recording/reproducing apparatus 1 of the first example, it is possible to adequately protect the information recorded on the encryption data recording part 43 by the relatively easy method such that the sticker 42 is attached. Additionally, by only peeling off the sticker 42 at the time of disposal, it is possible to protect the recorded encryption data, so that it is extremely useful in practice.

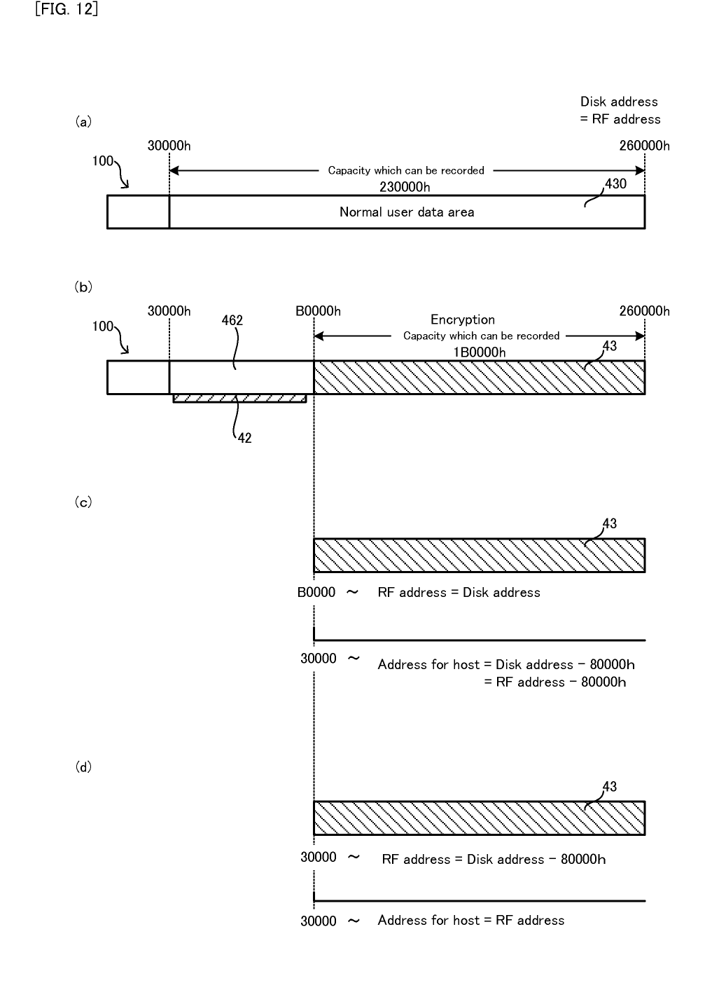

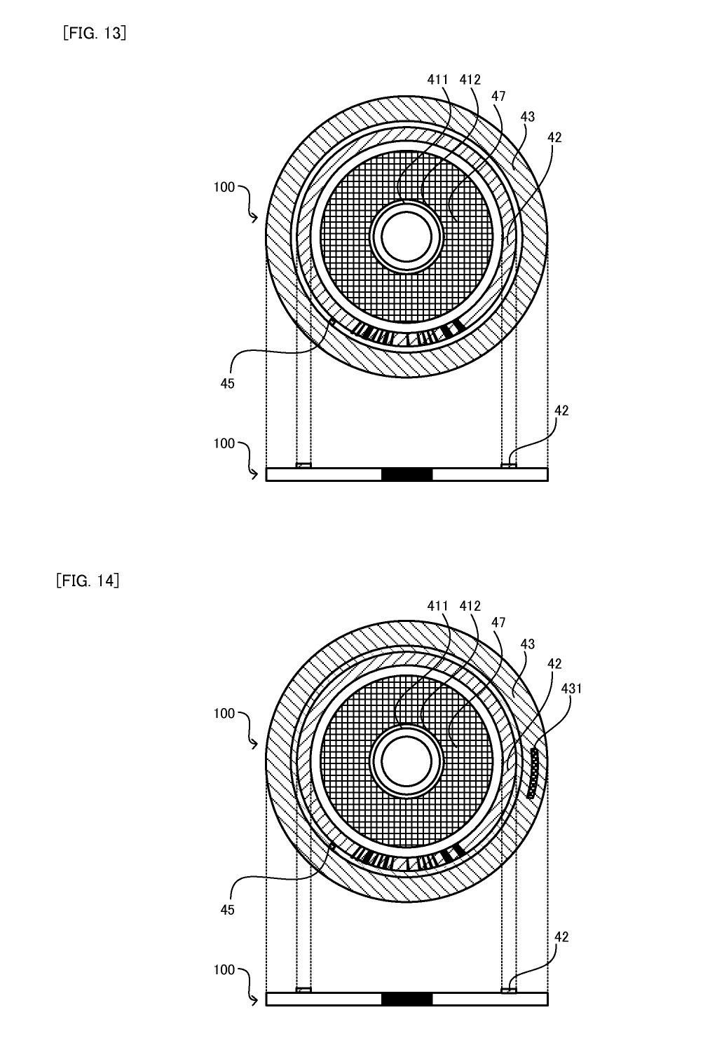

FIG. 12 is a cross-sectional view showing the data formation of the recording medium 100 and various addresses corresponding to the data formation in the first example (a: a data formation under a condition in which the sticker 42 is not attached, b: a data formation under a condition in which the sticker 42 is attached, c: a RF address and an address for host of the encryption data recording part 43 under a condition in which a disk address and the RF address are matched on the recording medium 100, d: a RF address and an address for host of the encryption data recording part 43 under a condition in which a disk address and the RF address are not matched on the recording medium 100).

As shown in FIG. 12(a), in the general recording medium, to which the sticker 42 is not attached, the normal user data area 430 dominates from 30000h to 260000h, for example. At this time, a capacity which can be recorded is 260000h−30000h=230000h. On the other hand, as shown in FIG. 12(b), in the recording medium 100 of the first example, to which the sticker 42 is attached, the encryption data recording part 43 dominates from B0000h to 260000h, for example. At this time, a capacity which can be recorded is 260000h−B0000h=1B0000h.

Here, it is not preferable that the address for host (e.g. an apparatus which can communicate data with the recording/reproducing apparatus 1, for example a computer) showing a start position of a user data area of a recording medium is changed according to whether or not there is the sticker 42 because the host is required a support. Namely, if the address for host is 30000h, it is preferable that the address for host showing a start position of a user data area of a recording medium is constant by 30000h whether there is the sticker 42 in order to ensure consistency with an existing host side application.

Consequently, the recording/reproducing apparatus 1 performs recording with adjusting various addresses such that the address for host corresponding to the start position of the encryption data recording part 43 becomes 30000h. At this time, as shown in FIG. 12(c), it is preferable to match a disk address of the recording medium 100 (e.g. an address physically determined on the based on a land prepit) and a referential RF address. It is preferable to send a host the disk address with an offset (which corresponds to the start position of the encryption data recording part 43). Specifically, for example, it is preferred to send the address for host, which equals the disk address minus 80000h. Alternatively, as shown in FIG. 12(d), the RF address is recorded such that the RF address can be used as the address for host; a mismatch between the RF address and the disk address may be controlled at the recording/reproducing apparatus 1. Specifically, for example, it is possible to control both address on the basis of the conversion equation: the RF address=the disk address−80000h. Anyhow, since the address for host corresponding to the start position of the encryption data recording part 43 becomes 30000h as described above, it is possible to use the recording medium 100 of the first example without asking the support to the host side.

### (2) Second Example

Next, with reference to FIG. 13 to FIG. 18, the explanation will be given on a recording medium 100 of a second example, and the structure and operation processing of a recording/reproducing apparatus 1, which can record and reproduce the recording medium 100. Incidentally, the same components and steps as those shown in aforementioned FIG. 1 to FIG. 12 carry the same numerical references, and the explanation thereof will be omitted as occasion demands.

(2-1) Structure

(2-1-1) Recording Medium 100 of Second Example

FIG. 13 are a top view and a cross-sectional view conceptually showing the basic structure of a recording medium 100 of a second example.

As shown in FIG. 13, the radius of the sticker 42 of the recording medium 100 of the second example is larger than that of the first example. Specifically, for example, the sticker 42 of the recording medium 100 of the second example dominates an area with a radius of 40 to 45 mm. In the inner circumference side of the sticker 42, an unencrypted data recording part 47 is formed as a conventionally recording area. In the outer circumference side of the sticker 42, the encryption data recording part 43, where a general drive can not access, is formed. Consequently, it is possible to simultaneously carry data which does not need to be encrypted, and data which is required to encrypt by one recording medium 100.

(2-1-2) Recording Medium 100 of Altered Embodiment of Second Example

Next, with reference to FIG. 14, the explanation will be given on an altered embodiment of the recording medium 100 of the second example shown in FIG. 13.

FIG. 14 are a top view and a cross-sectional view conceptually showing the basic structure of a recording medium 100 of an altered embodiment of the second example.

As shown in FIG. 14, the recording medium 100 of the altered embodiment of the second example is further provided with a second encryption key recording part 431 where a key for encryption and decryption is recorded. This second encryption key recording part 431 dominates a predetermined area in the recording layer 46. The position of the second encryption key recording part 431 is specified on the basis of the encryption key 424 of the sticker 42. This example shows it is not necessarily that the key for encrypting and decrypting the encryption data is directly recorded on the sticker 42.

(2-2) Operation

Next, a explanation will be given on an operation at a time when the recording medium 100 is recorded or reproduced by each of a general recording/reproducing apparatus and the recording/reproducing apparatus 1 of the second example.

(2-2-1) Operation of General Recording/Reproducing Apparatus

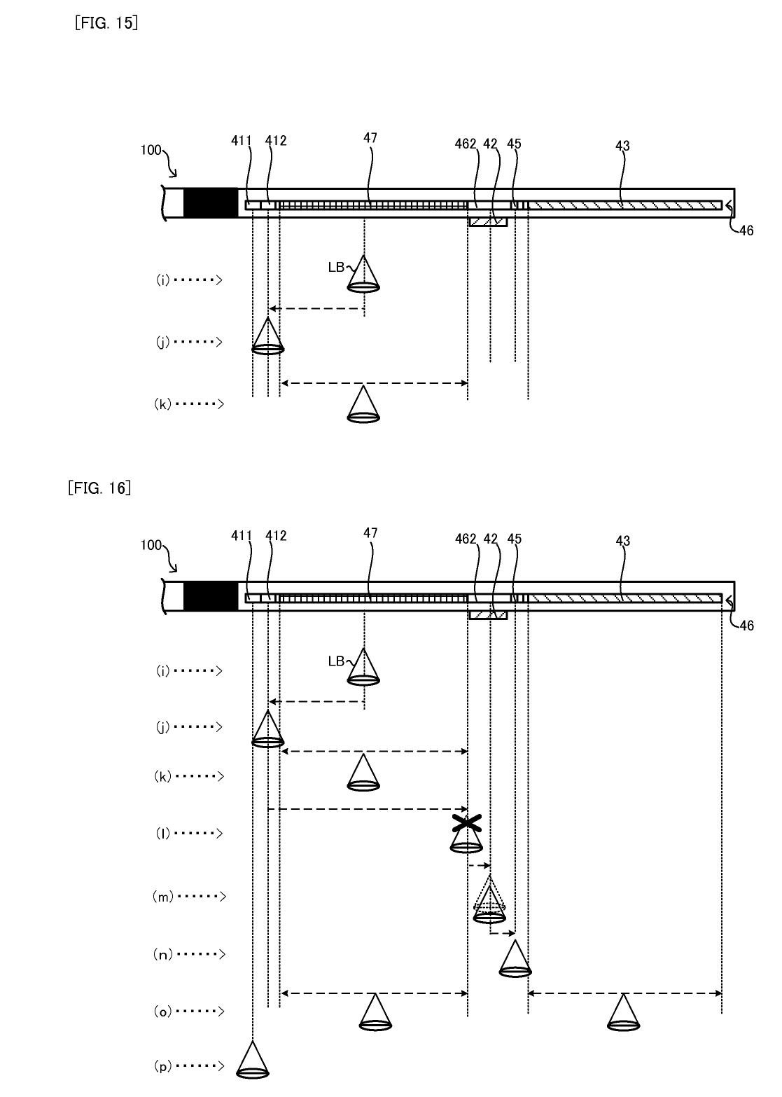

FIG. 15 is a conceptual diagram temporally showing a condition in which the recording medium 100 of the second example is recorded or reproduced by the general recording/reproducing apparatus with the cross-sectional view of the recording medium 100.

As the cross-sectional view of the recording medium 100 shown in FIG. 15, the recording layer 46 of the recording medium 100 of the second example is composed of the recording-power adjusting part 411, the disk information part 412, the unencrypted data recording part 47, the sticker-surrounding impossibly accessing part 462, the sticker-angle controlling mark 45 and the encryption data recording part 43 which are formed in the direction from the center hole to the outer circumference side.

When the aforementioned recording medium 100 is recorded or reproduced by the general recording/reproducing apparatus, the operation is as shown in FIG. 15(i) to FIG. 15(k). Incidentally, when a start-up operation is performed with a condition in which the irradiation position of the laser beam LB is in the unencrypted data recording part 47, in a similar way to a general recording medium, as shown in FIG. 15(i), focusing in and adjusting servo gain are performed; as shown in FIG. 15(j), the optical pickup 13 reads disk information by displacing to the position of the disk information part 412; as shown in FIG. 15(k), it is possible to record and reproduce unencrypted data within the unencrypted data recording part 47. However, it is impossible to access to the encryption data recording part 43 in the outer circumference side of the sticker 42 because the sticker dominate the area with a radius of 40 to 45 mm.

(2-2-2) Operation of Recording/Reproducing Apparatus 1 of Second Example

With reference to FIG. 16 to FIG. 18, the explanation will be given on the operation of the recording/reproducing apparatus 1 of the second example.

FIG. 16 is a conceptual diagram temporally showing a condition in which the recording medium 100 of the second example is recorded or reproduced by a recording/reproducing apparatus 1 of this example with the cross-sectional view of the recording medium 100.

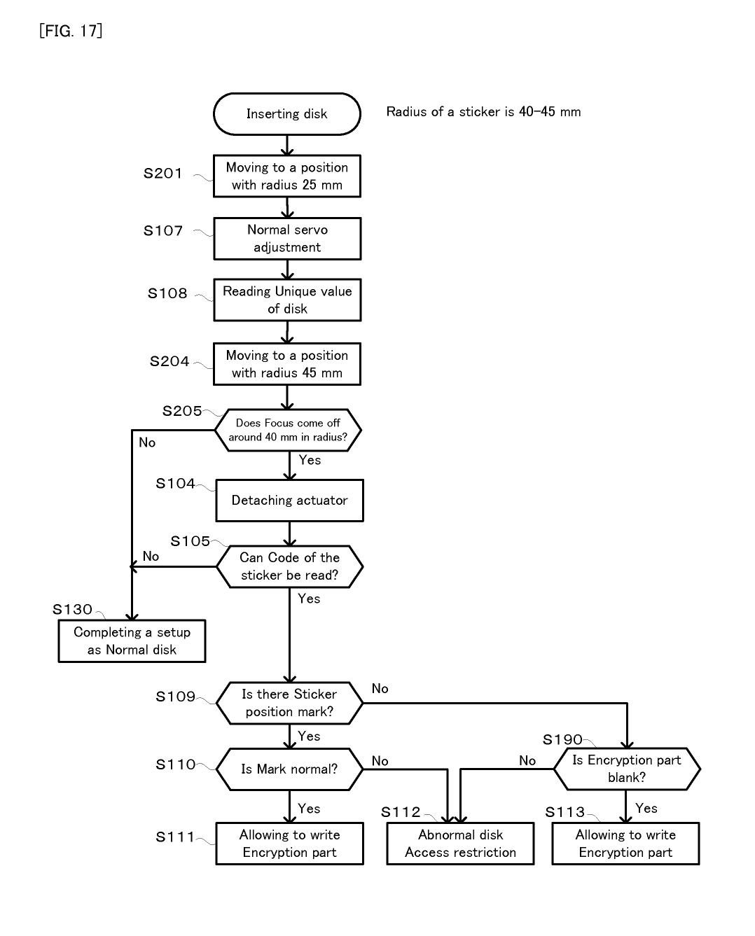

As shown in FIG. 16(i) to FIG. 16(j), the recording/reproducing apparatus 1 of the second example can record and reproduce not only the unencrypted data recording part 47 but also the encryption data recording part 43 of the recording medium 100 of the second example unlike the general recording/reproducing apparatus shown in FIG. 15. An additional explanation will be given on the FIG. 16(i) to FIG. 16(j) with relating to steps of the flowchart in FIG. 17.

FIG. 17 is a flowchart showing the operation of the recording/reproducing apparatus 1 of the second example.

As shown in FIG. 17, the recording/reproducing apparatus 1 of the second example, first, displaces the optical pickup 13 to a position with radius 25 mm on the recording medium 100, in other words within the unencrypted data recording part 47 (step S201). This condition is shown in FIG. 16(i). Then, a normal servo adjustment is performed (step S107), after that, a disk unique value is read from the disk information part 412 (step S108). This condition is shown in FIG. 16(j). At this time, as shown in FIG. 16(k), it is possible to record and reproduce the encrypted data in the unencrypted data recording part 47. Next, the optical pickup 13 is displaced to a position with radius 42 mm on the recording medium 100, in other words in a range of 40˜45 mm in radius where there is the sticker 42 (step S204). On the way, specifically around 40 mm in radius, it is judged whether or not a focus comes off, in other words whether or not there is the sticker 42 (step S205). This condition is shown in FIG. 16(l). Here, if the focus does not come off (the step S205: NO), since the sticker 42 is not attached, a special adjustment is unnecessary, thereby a setup is completed as a normal recording medium (step S130). On the other hand, if the focus comes off (the step S205: YES), the objective lens is detached by the actuator 131 such that the lens height becomes a height where the laser beam LB is focused on the sticker data layer 426 (step S104). This condition is shown in FIG. 16(m). Consequently, the recording/reproducing apparatus 1 of the second example discriminates that data is concealed in an area which is not accessed usually by there being the sticker 42 at a specific position. Herewith, the focus is kept. Then, it is judged whether or not a code recorded on the sticker data layer 426 of the sticker 42 (especially, the encryption key 424) can be read by the optical pickup 13 (step S105). Next, the optical pickup 13 is displaced to the position of the sticker-angle controlling part 44 in the outer circumference, and it is judged whether or not there is the sticker-angle controlling mark 45 (step S109). This condition is shown in FIG. 16(n). Here, if there is the sticker-angle controlling mark 45 already (the step S109: YES), it is judged whether or not the position of the sticker-angle controlling mark 45 is correct (step S110). Here, if it is judged that the position of the sticker-angle controlling mark 45 is correct (the step S110: YES), it is allowed to record data on the encryption data part 43 (step S111). This condition is shown in FIG. 16(o). Incidentally, an OPC processing for determining power at this time is performed at the recording-power adjusting part 411. This condition is shown in FIG. 16(p). Incidentally, if there is not the sticker-angle controlling mark 45 (the step S109: NO), or if the position of the sticker-angle controlling mark 45 is not correct (the step S110: NO), a processing is the same processing shown in FIG. 11. Consequently, the recording/reproducing apparatus 1 of the second example can record and reproduce not only the unencrypted data recording part 47 but also the encryption data recording part 43 of the recording medium 100 of the second example.

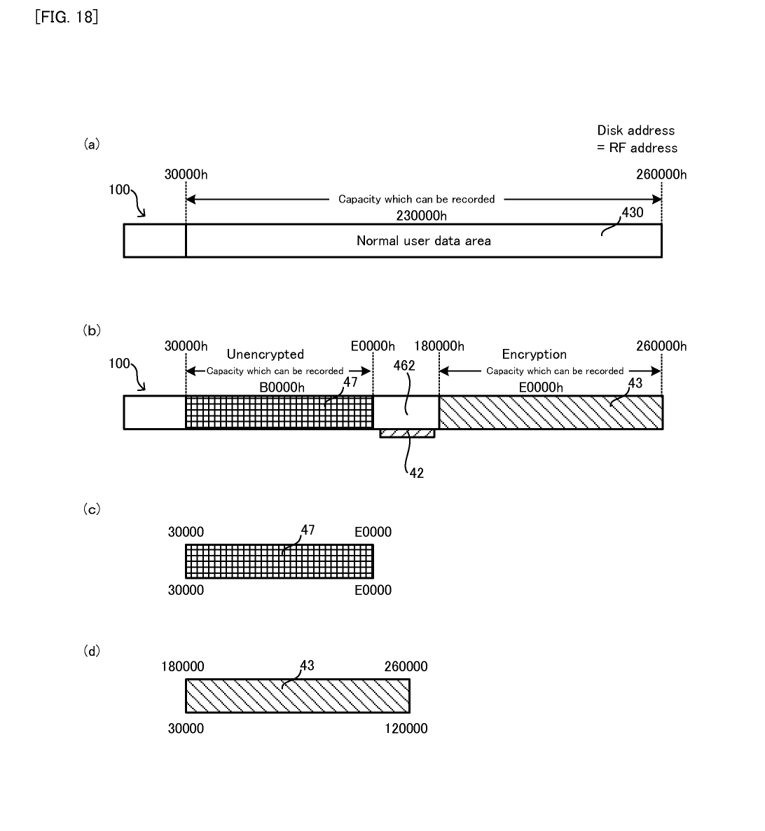

FIG. 18 is a cross-sectional view showing the data formation of the recording medium 100 and various addresses corresponding to the data formation in the second example (a: a data formation under a condition in which the sticker 42 is not attached, b: a data formation under a condition in which the sticker 42 is attached, c: a RF address and an address for host of the unencrypted data recording part 47, d: a RF address and an address for host of the encryption data recording part 43).

FIG. 18(a) is a figure which similar to FIG. 12(a). On the other hand, FIG. 18(b) is different from FIG. 12(b) as follows: the attached position of the sticker 42; the unencrypted data recording part 47 dominates from 30000h to E0000h, for example; crossing over the sticker 42; the encryption data recording part 43 dominates from 180000h to 260000h, for example.

At this time, as shown in FIG. 18(c) and FIG. 18(d), it is possible to get a host to pretend that there are two recording mediums by the address for host of each of the unencrypted data recording part 47 and the encryption data recording part 43 starting from 30000h. Of course, it is possible to show only any one of data recording parts.

### (3) Third Example

Next, with reference to FIG. 19 to FIG. 22, the explanation will be given on the structure of a recording medium 100 and the attaching operation of a sticker in a third example. Incidentally, in FIG. 19 to FIG. 22, the same components and steps as those shown in aforementioned FIG. 1 to FIG. 12 carry the same numerical references, and the explanation thereof will be omitted as occasion demands.

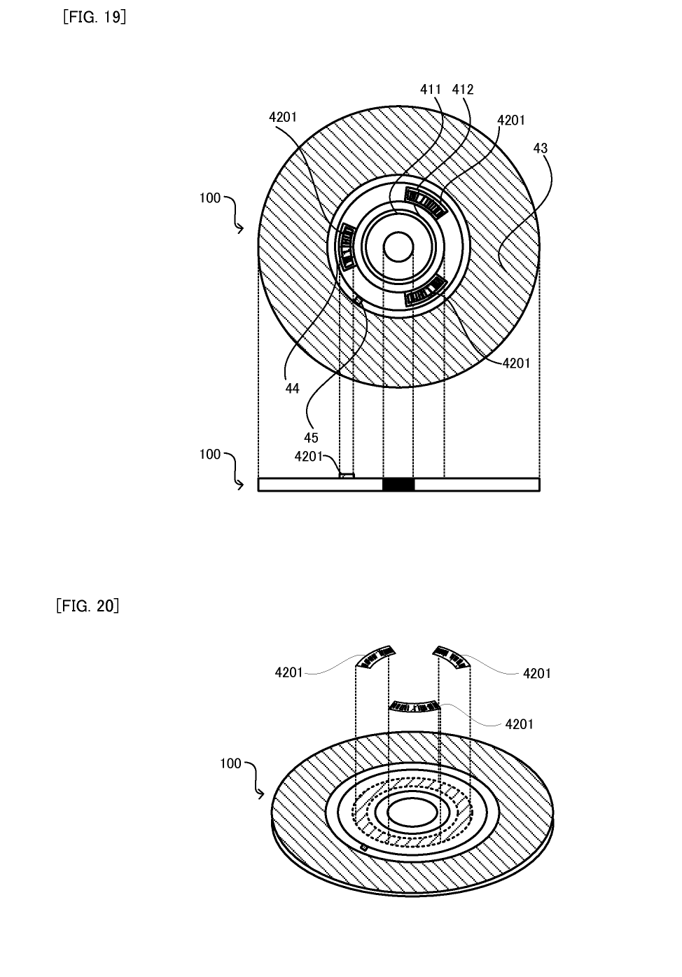

FIG. 19 are a top view and a cross-sectional view conceptually showing the basic structure of a recording medium 100 of a third example. FIG. 20 is a perspective view schematically showing the recording medium 100 and three stickers attached to the recording surface of the recoding medium 100 in the third example.

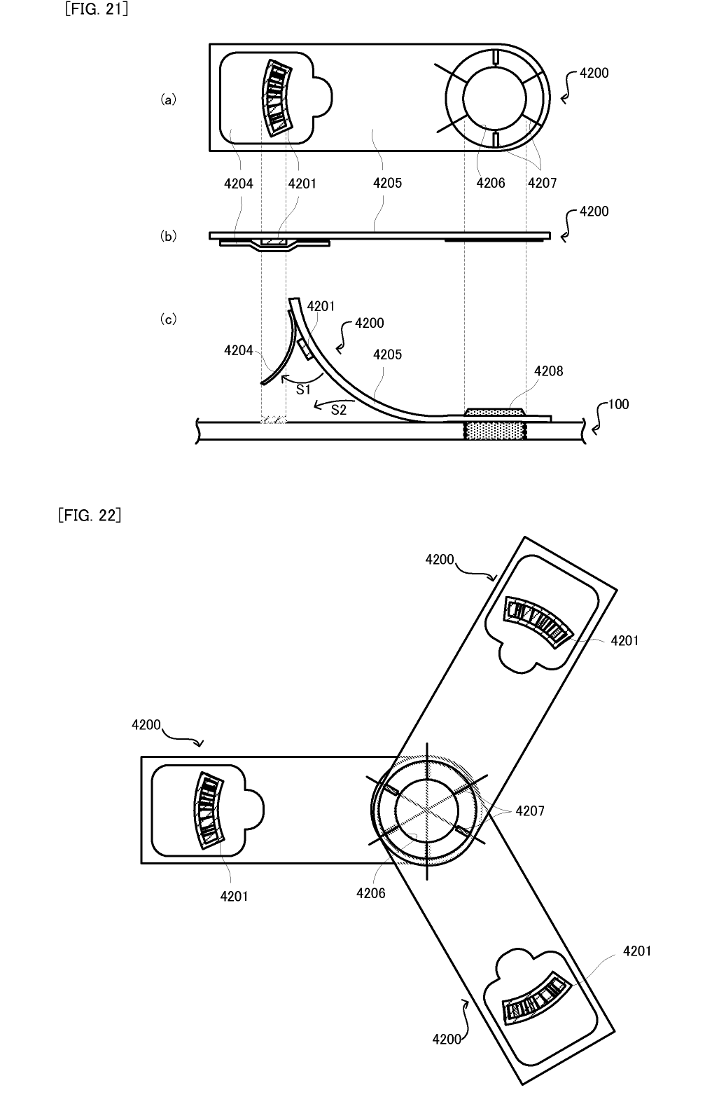

As shown in FIG. 19 and FIG. 20, an arc-shaped sticker 4201 is attached to the recording medium 100 of the third example unlike the aforementioned example. According to this arc-shaped sticker 4201, since an occupying space is narrower than a ring-shaped sticker which occupies the area of a square whose side equals to the diameter of the ring-shaped sticker, it is expected to reduce costs. Additionally, when user attaches the sticker in person, it becomes easy to attach the sticker to a correct position by using a sticker attaching kit 4200, which is one specific example of the “attaching kit” of the present invention, as shown in FIG. 21. At this time, since the rotational speed of the recording medium 100 is faster than the mobile speed of the optical pickup 13 in a radial direction, if the central angle of the arc-shaped sticker 4201 is greater than or equal to a predetermined angle, it is possible to prevent keeping focus in a similar way to the ring-shaped sticker. In other words, in this example, it is possible to perform the operation shown in FIG. 11 or FIG. 17. Incidentally, the term the “predetermined angle” here can be specified as a central angle which can prevent keeping focus by experiments, experiences or simulations in which the mobile speed of the optical pickup 13 in the radial direction, the rotational speed of the recording medium 10, an attaching position, the number of stickers attached and the like are considered.

Incidentally, it is not preferable that the number of arc-shaped stickers 4201 attached is too few in view of balance. For example, when the number of stickers attached is one, since the symmetry property is wrong, the imbalance of the recording medium 100 increases, thereby there is a possibility of defective record. When the number of stickers attached is two, the symmetry property is improved because the stickers are symmetric with respect to the center of the recording medium 100, but the balance between an axis connecting two stickers and an axis perpendicular to it is wrong. Therefore, it is preferable that the number of stickers is three or more as shown in FIG. 19 and FIG. 20. When the number of stickers attached is three, it is preferable that three stickers are disposed at even angle of 120 degrees around the center of the recording medium 100, respectively.

Incidentally, when the number of arc-shaped stickers 4201 attached is plural number, the encryption key may be made up of arc-shaped stickers 4201; the encryption key may be recorded on one of arc-shaped stickers 4201, and the other arc-shaped stickers 4201 may be a dummy. However, it is not preferable to attach the same three stickers because copying becomes easy.

Next, with reference to FIG. 21 and FIG. 22, an additional explanation will be given on the sticker attaching kit 4200, which is used in attaching the arc-shaped sticker 4201 later.

FIG. 21 is a cross-sectional view conceptually showing the basic structure of a sticker attaching kit 4200 of the third example. FIG. 22 is a top view conceptually showing a condition in which three arc-shaped stickers 4201 are attached by using the sticker attaching kit 4200 of the third example.

As shown in the top view of FIG. 21(a) and the side view of FIG. 21(b), the sticker attaching kit 4200 of the third example is provided with: a pasteboard 4205 which is transparent and has an oblong shape; the arc-shaped sticker 4201, which has one surface attached to the pasteboard 4205 and other surface being an attaching surface, and on which an encryption key is recorded; a protection sheet 4204 for protecting the attaching surface of the arc-shaped sticker 4201; a board-hole 4206, whose diameter is nearly equal to that of the center hole of the recording medium 100, for adjusting a center; and angle mark 4207 for adjusting an attaching angle.

For more detail, the interval between the arc-shaped sticker 4201 and the board-hole 4206 corresponds to the attaching position on the recording medium 100. The encryption key recorded on the arc-shaped sticker 4201 may be all of a key for encryption or a part of the key. If it is a part of the key, the other part of the key is recorded on other stickers, and the recording/reproducing apparatus 1 reads them and rebuilds the key. It is preferable for the operation shown in FIG. 21(c) that the adhesion force of the attaching surface of the arc-shaped sticker 4201 is greater than that of a surface which faces the pasteboard 4205. In other words, it is necessary to easily fall off the pasteboard 4205 after attaching the arc-shaped sticker 4201 to the recording/reducing apparatus 1. The protection sheet 4204 attached to the pasteboard 4205 such that the protection sheet 4204 surrounds the surrounding area of the arc-shaped sticker 4201. It is preferable that one surface of the protection sheet 4202 which faces the attaching surface of the arc-shaped sticker 4201 does not touch the attaching surface. The angle mark 4207 depends on the number of stickers attached; the angle mark 4207 is formed at every 180 degree/3=60 degree if the number of stickers attached is three.

It is possible to attach the arc-shaped sticker 4201 by the aforementioned sticker attaching kit 4200 according to the procedure shown in FIG. 21(c). Namely, first, the center hole of the recording medium 100 and the board-hole 4206 are put on a projection 4208. At this time, if the number of stickers attached is three, as shown in FIG. 22, the angle mark 4207 is adjusted such that stickers are disposed at every 120 degrees. Return to FIG. 21(c) again, the protection sheet 4204 is peeled off with a condition in which the pasteboard 4205 is warped (step S1). Thus, the attaching surface of the arc-shaped sticker 4201 appears. The warped pasteboard 4205 is turned back to normal (step S2). As a result, it is possible to attach the arc-shaped sticker 4201 to a preferred position.

As described above, according to this example, it is possible to record and reproduce the encryption data recording part 43 of the recording medium 100. Additionally, it is possible to protect the recorded encryption data by relatively easy action such that the sticker 42 or the arc-shaped sticker 4201 is peeled off in scrapping the recording medium 100.

Incidentally, the present invention is not limited to the aforementioned example, but various changes may be made, if desired, without departing from the essence or spirit of the invention which can be read from the claims and the entire specification. A recording medium, an attaching kit for attaching an encryption key sticker to the recording medium, and a recording apparatus and a reproducing apparatus for the recording medium, all of which involve such changes, are also intended to be within the technical scope of the present invention.

### INDUSTRIAL APPLICABILITY

The recording medium, the attaching kit for attaching the encryption key sticker to the recording medium, and the recording apparatus and the reproducing apparatus for the recording medium of the present invention can be applied to a technical field relates to a recording medium which can relatively easily protect content recorded in a disk-shaped recording medium such as an optical disk, an attaching kit for attaching an encryption key to the recording medium, and a recording apparatus and a reproducing apparatus for the recording medium.

1-15. (canceled)

16. A recording medium comprising:
a sticker, which is attached to a predetermined position of said recording medium, having at least an encryption key previously recorded on an electromagnetically and optically readable state; and
a recording area for recording data, which includes encryption data encrypted based on at least the recorded encryption key, in the electromagnetically and optically readable state.

17. The recording medium according to the claim 15, wherein
said recording medium has a disk shape,
said sticker has a ring shape or an arc shape, which is a part of the ring shape,
a center of a ring of said sticker coincides with a center of said disk-shaped recording medium, and
an external diameter of the ring of said sticker is less than a radius of said disk-shaped recording medium.

18. The recording medium according to the claim 17, wherein
said attached sticker includes: a start detecting part indicating a reading start position of said sticker; a timing synchronous part for synchronizing a reading timing for a succeeding data; a standard position part indicating a standard position of said sticker in a circumferential direction of said recording medium; and the encryption key, and
the start detecting part, the timing synchronous part, the standard position part and the encryption key are arranged in order of the start detecting part, the timing synchronous part, the standard position part and the encryption key along a reading direction.

19. The recording medium according to the claim 18, wherein
said disk-shaped recording medium further comprises an angle controlling area which records therein an angle controlling mark which becomes a standard for judging whether or not a position of said attached sticker is correct,
the angle controlling mark is recorded on the angle controlling area such that a straight line connecting the standard position part and a center of said disk-shaped recording medium and a straight line connecting the angle controlling mark and the center of said disk-shaped recording medium makes a predetermined angle with each other.

20. The recording medium according to the claim 19, wherein the predetermined angle is derived on the basis of at least unique information of said recording medium in recording the angle controlling mark.

21. The recording medium according to the claim 16, wherein
said attached sticker comprises a main part which is a part of said attached sticker, and a separated part which is other part of said attached sticker,
when said attached sticker is peeled off, the main part and the separated part are separated from each other.

22. The recording medium according to the claim 17, wherein
said recording area also has a ring shape in said disk-shaped recording medium,
a center of said ring-shaped recording area coincides with the center of said disk-shaped recording medium, and
said recording medium further comprises an information area, where an unique information which is needed in recording or reproducing is recorded, at an inside of said attached sticker.

23. The recording medium according to the claim 22, wherein an internal diameter of the ring of said sticker is less than an internal diameter of said ring-shaped recording area.

24. The recording medium according to the claim 22, wherein
an internal diameter of the ring of said sticker is larger than an internal diameter of said ring-shaped recording area, and
the external diameter of the ring of said sticker is less than an external diameter of said ring-shaped recording area.

25. The recording medium according to the claim 17, wherein if said sticker has an arc shape, a plurality of arc-shaped stickers are located on an identical radial position of said disk-shaped recording medium.

26. The recording medium according to the claim 25, wherein the encryption key is recorded on any one of said plurality of arc-shaped stickers.

27. The recording medium according to the claim 25, wherein the encryption key is separately recorded on each of said plurality of arc-shaped stickers.

28. An attaching kit for attaching said arc-shaped sticker according to claim 25 to said recording medium, which has a disk shape, said attaching kit comprising:
a pasteboard which is transparent and has an oblong shape;
said arc-shaped sticker, which is attached to said pasteboard by one surface where the encryption key is recorded, and has other surface which is an attaching surface for attaching said arc-shaped sticker to said recording medium;
a protection sheet for protecting the attaching surface;
a board-hole, whose diameter is equal to a center hole formed in said recording medium, for adjusting a center; and
an angle mark, which is placed at a surrounding area of said board-hole, for adjusting an attaching angle of each of said plurality of arc-shaped stickers.

29. A recording apparatus for recording data on the recording medium according to claim 16, said recording apparatus comprising:
a reading device for electromagnetically and optically reading an encryption key which is recorded on a stacker attached to said recording medium;
an encrypting device for encrypting recording target data on the basis of at least the read encryption key; and
a recording device for recording the encrypted recording target data on said recording medium.

30. A reproducing apparatus for reproducing an encryption data recorded on the recording medium according to claim 16, said reproducing apparatus comprising:
a reading device for electromagnetically and optically reading an encryption key which is recorded on a stacker attached to said recording medium, and the recorded encryption data; and
a decoding device for decoding the read encryption data on the basis of the read encryption key.
